(19) United States
(12) Patent Application Publication
(10) Pub. No.: US 2021/0274108 A1
(43) Pub. Date: Sep. 2, 2021

(54) A Device Having Exactly Two Cameras and a Method of Generating Two Images Using the Device

(71) Applicant: Vestel Elektronik Sanayi ve Ticaret A.S., Manisa (TR)

(72) Inventor: Barbaros KÍRÍSKEN, Manisa (TR)

(21) Appl. No.: 17/260,884

(22) PCT Filed: Jul. 17, 2018
(86) PCT No.: PCT/EP2018/069417

§ 371 Date: Jan. 15, 2021

(51) Int. Cl. H04N 5/33; H04N 13/25

(52) U.S. Cl. CPC H04N 5/332; H04N 13/25

(57) ABSTRACT

Device having exactly two cameras. The first camera is a red-green-blue (RGB) camera for capturing RGB images. The second camera is either: (i) an RGB and infrared (IR) camera for capturing RGB images and IR images, the second camera having a selectively operable IR pass filter which can be selectively operated to pass only IR so that the second camera can be used to selectively capture an RGB image or an IR image; or (ii) an IR camera for capturing IR images, and the device comprising a processor arranged to process IR images captured by the second camera to produce RGB images from IR images captured by the second camera by using RGB information from images captured by the first camera. The device can selectively provide two RGB images of a scene or one RGB image and an IR image of a scene from the two cameras.

### CROSS REFERENCE TO RELATED APPLICATION

This application is a US 371 application from PCT/EP2018/069417 entitled “A Device Having Exactly Two Cameras and a Method of Generating Two Images Using the Device” filed on Jul. 17, 2018 and published as WO 2020/015821 A1 on Jan. 23, 2020. The technical disclosures of every application and publication listed in this paragraph are hereby incorporated herein by reference.

### TECHNICAL FIELD

The present disclosure relates to a device having exactly two cameras and a method of generating two images using the device.

### BACKGROUND

It is becoming increasingly desirable for users to take high quality photographs, particularly, for example, using smartphones and other consumer devices, without having to use complex or technically advanced cameras. Dual camera photography is of increasing interest.

Conventionally, photographs, taken either using a single camera or dual cameras, are red-blue-green (RGB) images. In the case of dual cameras, an RGB image is produced, using information captured by both cameras. It is also becoming of interest to also use infrared (IR) information and IR images in photography, for example for enhanced image details, for greater editing capabilities, and for certain special effects.

### SUMMARY

According to a first aspect disclosed herein, there is provided a device having exactly two cameras;

the first camera being a red-green-blue RGB camera for capturing RGB images;

the second camera being either:

(i) an RGB and infrared IR camera for capturing RGB images and IR images, the second camera having a selectively operable IR pass filter which can be selectively operated to pass only IR so that the second camera can be used to selectively capture an RGB image or an IR image, or

(ii) an IR camera for capturing IR images, and the device comprising a processor arranged to process IR images captured by the second camera to produce RGB images from IR images captured by the second camera by using RGB information from images captured by the first camera;

whereby the device can selectively provide two RGB images of a scene or one RGB image and an IR image of a scene from the two cameras.

In an example, in the case that the second camera is an IR camera, the IR camera comprises an IR sensor chip for capturing IR information of a scene.

In an example, the device comprises a processor for combining the two RGB image of a scene or the one RGB image and the IR image of a scene to generate a single image of said scene.

In an example, the device comprises an IR flash for illuminating a scene with IR such that reflected IR radiation may be captured by the second camera.

In an example, at least one of the first camera and the second camera comprise a fixed lens assembly for capturing an image of a scene.

In an example, in the case that the second camera is an RGB and IR camera, the selectively operable IR filter comprises a microelectromechanical systems MEMS shutter.

According to a second aspect disclosed herein, there is provided a method of generating two images of a scene using a device having exactly two cameras, the method comprising:

capturing an RGB image of the scene by a first camera of the device;

capturing a second image of the scene by a second camera of the device, the second image being either an RGB image or an IR image of the scene;

wherein a said IR second image is obtained by either:

(i) selectively activating an IR-pass filter of the second camera in the case that the second camera is an RGB and infrared IR camera such that the second camera only captures an IR image; or

(ii) capturing an IR image of the scene in the case that the second camera is an IR camera for capturing IR images; and

wherein a said RGB second image is obtained by either:

(i) selectively de-activating an IR-pass filter of the second camera in the case that the second camera is an RGB and infrared IR camera such that the second camera captures an RGB image; or

(ii) capturing an IR image of the scene in the case that the second camera is an IR camera for capturing IR images, and processing the IR image by a processor of the device to produce RGB images from IR images captured by the second camera by using RGB information from the image captured by the first camera.

In an example, the method comprises combining the RGB image of the scene captured by the first camera with the second image of the scene captured by the second camera, to generate a single image of the scene.

In an example, the method comprises illuminating the scene with IR from an IR flash of the device, such that reflected IR radiation may be captured by the second camera of the device.

In an example, the device is a mobile user device.

### BRIEF DESCRIPTION OF THE DRAWINGS

To assist understanding of the present disclosure and to show how embodiments may be put into effect, reference is made by way of example to the accompanying drawings in which:

FIG. 1 shows schematically an example device comprising two cameras for capturing two images;

FIG. 2 shows schematically an example arrangement of the two cameras of FIG. 1;

FIGS. 3A and 3B shows schematically example configurations of the arrangement of FIG. 2 in use;

FIG. 4 shows schematically a second example device comprising two cameras for capturing two images;

FIG. 5 shows schematically an example arrangement of the two cameras of FIG. 4; and

FIG. 6 shows schematically an example configuration of the arrangement of FIG. 5 in use.

### DETAILED DESCRIPTION

As described above, dual camera photography and IR photography are of growing interest in allowing capture of higher quality photographs and/or for certain visual effects, which is becoming an increasingly important requirement of consumer devices. Dual cameras systems allow devices to generate a single, enhanced image by combining image information received from two cameras. For example, when taking a portrait photograph with a user device, a dual camera photograph may exhibit clearer facial features, or allow for light depth photography, depth maps, or combining more than one focus point into an image.

IR images are taken using IR radiation. IR images can exhibit greater detail when compared to RGB images, by, for example, enhancing visible features and bringing out details not easily detectable by the human eye.

Described herein is a device having exactly two cameras. The first camera is a red-green-blue RGB camera for capturing RGB images. The second camera is either: (i) an RGB and infrared IR camera for capturing RGB images and IR images, the second camera having a selectively operable IR pass filter which can be selectively operated to pass only IR so that the second camera can be used to selectively capture an RGB image or an IR image, or (ii) an IR camera for capturing IR images, and the device comprising a processor for processing IR images captured by the second camera to produce RGB images from IR images captured by the second camera by using RGB information from images captured by the first camera. The device can selectively provide two RGB images of a scene or one RGB image and an IR image of a scene from the two cameras.

Dual camera photography can provide greater detail about the scene being captured by a device. For example, using a device as described herein, the marginally different angles from which a first camera and a second camera capture image information of a scene may provide greater depth information and/or greater details of the scene. The information captured by both cameras can be combined by image processing methods to generate a highly detailed single image. In an example, two cameras be arranged to capture a Bokeh photograph as known in the art. In this example, dual camera photography may, for example, allow for plural focal points in the photograph. Alternatively or additionally, two cameras may capture the subject(s) in focus in greater detail, such that the subject(s) appears even more prominent than the lesser focussed areas of the Bokeh photograph. The need for such depth information may, for example, be of importance when the f-stop of at least one camera of the two cameras cannot be changed to capture a Bokeh image wherein the in-focus and out-of-focus areas are clearly distinguishable.

It is also known that IR information can also greatly enhance an image and detection of subtle details in a scene or subject, for example by providing details that may have otherwise not been captured by a camera when the camera is arranged to capture an RGB image. Owing to the increased detail provided by IR images, IR photography is highly useful in, for example, identity detection. For example, a smartphone requiring facial recognition to allow a person access to content of the smartphone will likely capture IR information of the face of the person. The sensor chips used in digital cameras are often capable of sensing IR information when an image is captured.

It would therefore be beneficial for a device to be able to capture RGB images as well as IR images of an environment when desired. In principle, a total of three cameras can be used to allow this, with two of the cameras being RGB cameras and one being an IR camera. However, this is an expensive solution as each camera represents a manufacturing cost. Examples described herein provide a device that enables dual camera RGB photography and IR imaging when desired, using just two cameras.

The device may be, for example, a smartphone, a dedicated digital camera, a tablet computer, etc., wherein a first camera and the second camera of the device are arranged to each capture an image of the scene. The images may in an example be captured simultaneously. The resulting two RGB images or the one RGB image and an IR image may be used or stored as separate images. The separate images are then able to be edited and/or combined at a later time. Alternatively or additionally the images may be combined in order to derive a single high quality image of the scene, comprising the features of dual camera photography and optionally IR imaging.

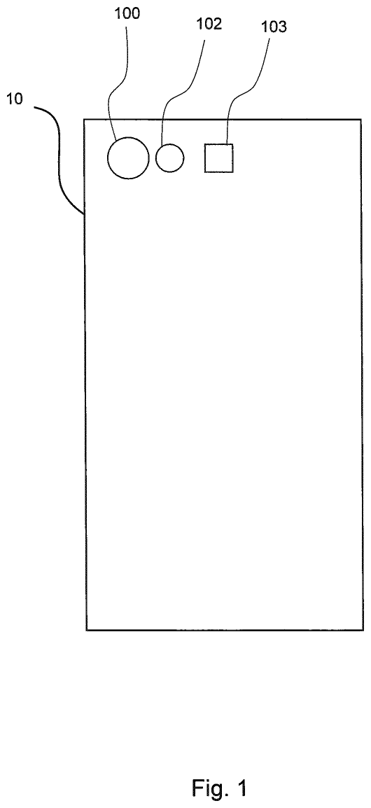

Referring now to the drawings, there is shown in FIG. 1 an example device 10 comprising a first camera 100, the first camera being arranged to capture a first RGB image, and a second camera 102 being an RGB and IR camera for selectively capturing an RGB image or an IR image. Examples of both cameras 100, 102 are described in greater detail further below. Optionally, the device 10 may comprise an IR flash 103 for generating IR to illuminate a scene or subject.

In this example, the device 10 is a smartphone 10, comprising the first camera 100, the second camera 102 and the IR flash 103 on the rear face of the smartphone 10. Additionally or alternatively, the smartphone 10 may comprise both cameras 100, 102, and optionally the IR flash 103, on the forward face of the smartphone 10. In other examples, the device 10 may be a camera, a tablet, a personal computer, a laptop, etc. Each camera 100, 102, may have lenses of the same or a different type. For example, the first camera 100 may be a wide angle camera, and the second camera 102 may be a telephoto camera.

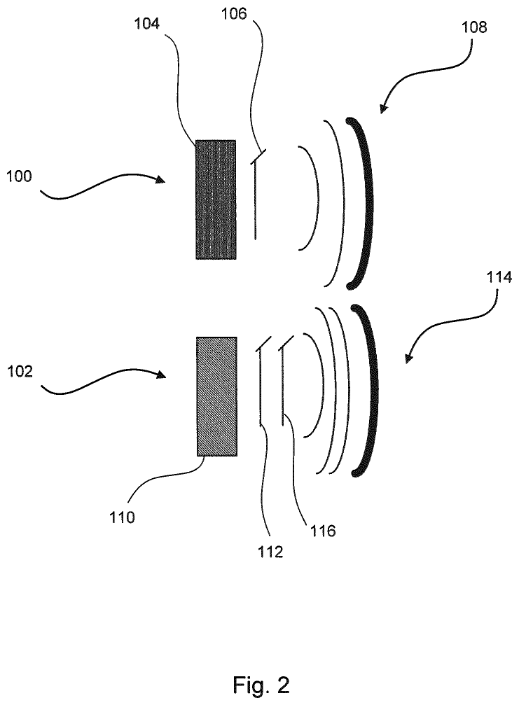

FIG. 2 is a top-down view of an example arrangement of the two cameras 100, 102 of the device 10 of FIG. 1. The first camera 100 is arranged to capture RGB images of a scene. In this example, the first camera 100 comprises a sensor 104, a camera shutter 106, and a lens arrangement 108. The camera shutter 106 may comprise for example a MEMS (microelectromechanical systems) shutter. When the first camera 100 is required to take a picture, the sensor 104 is arranged to receive RGB information of a scene.

Often, camera sensor chips automatically capture IR information even when the camera is arranged to capture an RGB image. To minimise or avoid the presence of such unwanted IR information, the first camera 100 may, in some examples, comprise an IR-block filter (not shown) for blocking IR and therefore preventing IR reaching the sensor 104 of the first camera 100. In an example, the IR-block filter may be fixed, such that the IR-block filter is always arranged to block IR information and to allow (only) RGB information to pass through the camera. The IR-block filter may be arranged to reflect and/or block particular wavelengths, or particular wavelength ranges, of IR, whilst allowing visible light to pass through, as known in the art per se.

The second camera 102 in this example is shown comprising a sensor 110, a camera shutter 112, a lens arrangement 114, and an IR-pass filter 116. The second camera 102 in this example can be considered an RGB and IR camera 102.

If an RGB image is required from the second camera 102, the IR-pass filter 116 can be operated to be ‘open’, such that the IR-pass filter 116 does not obstruct any radiation from reaching the camera sensor 110. RGB (and IR) radiation will therefore be able to pass through and be captured by the camera 100, selectively allowing the second camera 102 to capture an RGB image.

If an IR image is required from the second camera, the IR-pass filter 116 can be operated to be ‘closed’, such that the IR-pass filter selectively permits only IR radiation through to the sensor 110 and blocks RGB light. Thereby the second camera 102 selectively captures only an IR image.

The above-described definitions of an ‘open’ IR-pass filter 116 selectively allowing RGB (and IR) information to pass through the camera, and a ‘closed’ IR-pass filter 116 selectively blocking RGB information and allowing only IR information to pass through the camera, will be adhered to throughout the present description.

If present, the IR flash 103 may be operated to illuminate the scene to be captured with IR when an IR image is to be captured by the second camera 102.

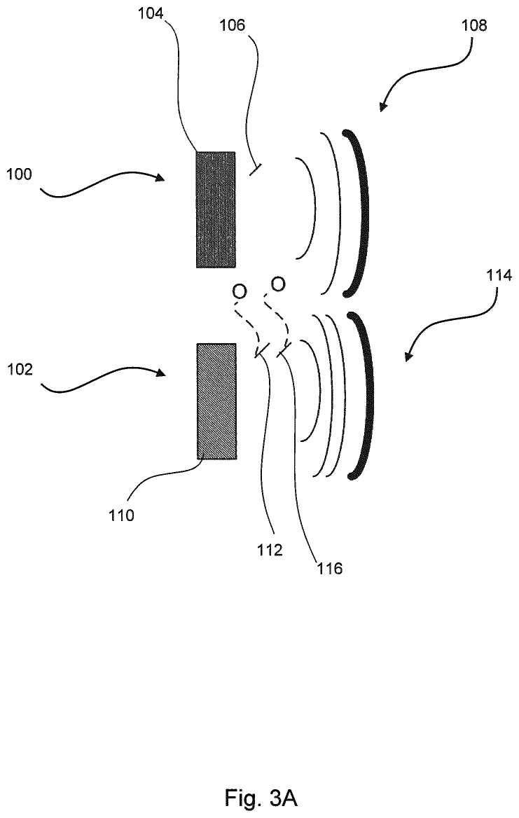

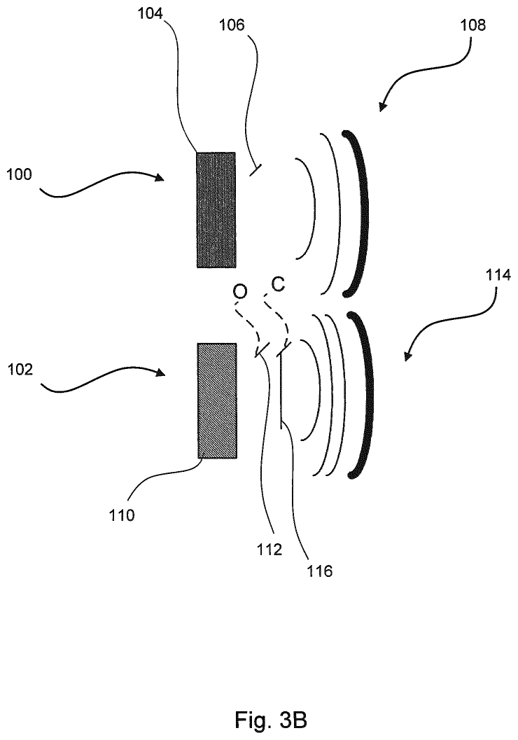

FIGS. 3A and 3B show the arrangement of FIG. 2 in two different example configurations for capturing images of a scene.

FIG. 3A demonstrates an example configuration of the arrangement of FIG. 2 for capturing two RGB images. The shutter 106 of the first camera 100 is open. At this instance the first camera 100 is arranged to capture a first RGB image. The shutter 112 of the second camera 102 is also open, such that the second camera 102 is arranged to capture an image. The IR-pass filter 116 of the second camera 102 is open in this example, thereby allowing RGB (and IR) information to pass through the second camera 102. The second camera 102 is therefore arranged to capture a second RGB image of the scene in this example.

FIG. 3B demonstrates another example configuration of the arrangement of FIG. 2 for capturing one RGB image and one IR image. As before, the shutter 106 of the first camera 100 is open, and the first camera 100 is arranged to capture a first RGB image. The shutter 112 of the second camera 102 is also open, such that the second camera 102 is arranged to capture an image. However the IR pass filter 116 is closed, such that RGB information is blocked, and only IR information is able to pass through the camera 102. The sensor 110 of the second camera 102 therefore only receives IR information, and the second camera 102 is arranged to capture an IR image.

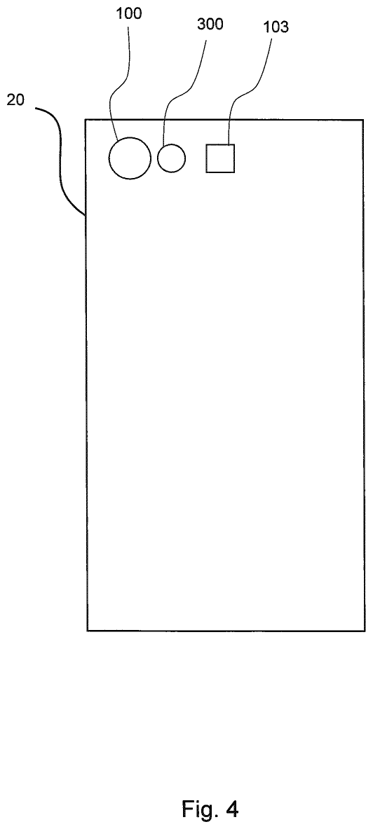

There is shown in FIG. 4 a second example device 20 comprising a first camera 100, the first camera 100 being arranged to capture a first RGB image, and a second camera 300 for capturing only IR images.

In the example device 20, the first camera 100 is as described above for the first example disclosed in FIGS. 1 to 3B. In this example, the device 20 is a smartphone 20, comprising the first camera 100, the second camera 300 and the IR flash 103 on the rear face of the smartphone 10. Additionally or alternatively, the smartphone 20 may comprise both cameras 100, 300, and optionally the IR flash 103, on the forward face of the smartphone 20. In other examples, the device 20 may be a camera, a tablet, a personal computer, a laptop, etc. Optionally, the device 20 may comprise an IR flash 103, as described above.

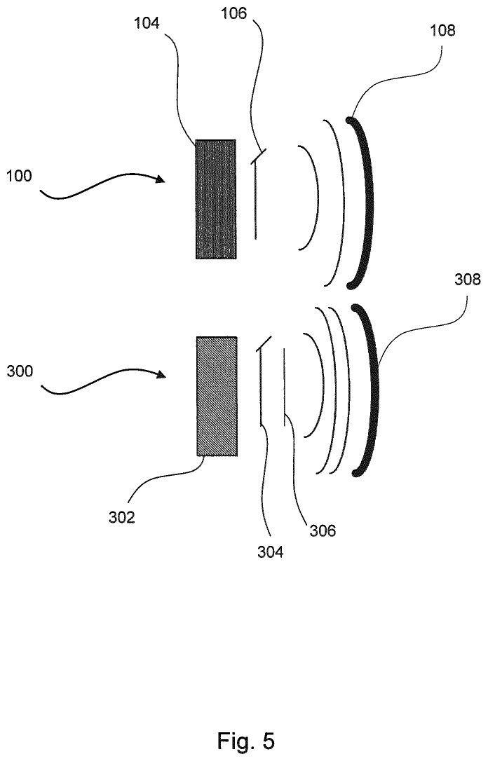

FIG. 5 is a top-down view of an example arrangement of the two cameras 100, 300 of the device 20 of FIG. 4. The first camera 100, as described above, is arranged to capture an RGB image of a scene. The second camera 300 is an IR only camera 300 arranged to capture IR images. The second camera 300 comprises a sensor 302, a camera shutter 304, a fixed IR-pass filter 306, and a lens arrangement 308. The camera shutter 304 may comprise for example a MEMS shutter. The fixed IR-pass filter 306 is arranged to only allow IR information to pass to the sensor 302. Therefore the fixed IR filter 116 will allow the second camera 300 to capture only IR images. In accordance with the language used above, the fixed IR-pass filter 116 may be considered as a permanently closed IR-pass filter 116, as the IR-pass filter 116 is arranged to always allow IR information to pass through the second camera 300, and to obstruct RGB information.

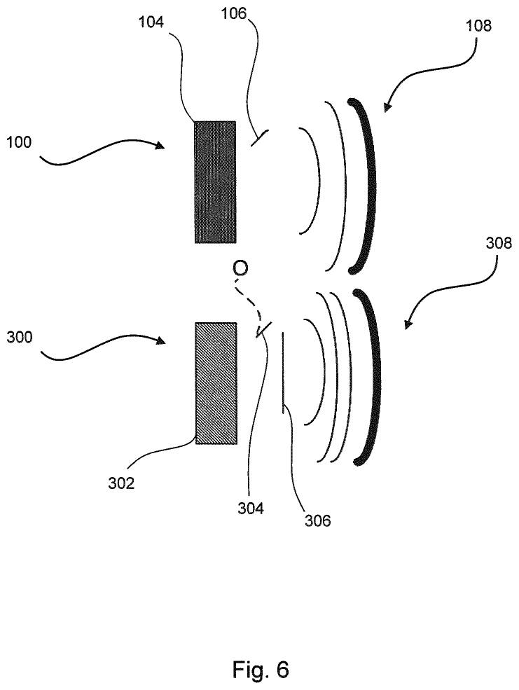

FIG. 6 shows the arrangement of FIG. 5 in an example configuration for capturing images of a scene. The shutter 106 of the first camera 100 is open. At this instance the first camera 100 is arranged to capture a first RGB image.

The shutter 304 of the second camera 300 is open, and the second camera 300 is arranged to capture an IR image of the scene. The fixed IR-pass filter 306 of the second camera 300 remains closed, such that the second camera 300 is arranged to only allow IR to pass through the camera 300, and block RGB information.

The example configuration shown in FIG. 6 may be used to achieve two RGB images, the first RGB image being from the first camera 100, and a second RGB image, using the RGB image from the first camera 100, and the IR image from the second camera, 300. In particular, in an example, the RGB image of the first camera 100 and the IR image of the second camera 300 may be transmitted to a processor (not shown). The processor may be incorporated in the device 20 comprising the first camera 100 and the second camera 300, or the processor may exist in a separate entity. The processor may be arranged to colour the IR image of the second camera 300 using the colour information from the RGB image captured by the first camera 100, by an image colouring method, colour reconstruction process or predictive colouring process as known in the art per se. That is, RGB data from the RGB image captured by the first camera 100 is used in a process to convert the IR image captured by the second camera 300 to a second RGB image

As an alternative to the second camera 300 having a fixed IR-pass filter 306 so that only IR is passed to the sensor, the second camera 300 may, for example, comprise an IR sensor chip. An IR sensor chip or IR camera 300 may be arranged to only receive radiation falling within the IR wavelength range of approximately 700 nm-1 mm. The IR sensor chip 300 may in one example comprise a sensor chip, and a covering material arranged to only permit IR radiation to pass through. The covering material may in one example comprise IR-only glass arranged to only allow IR radiation to pass through it. In another example, the IR sensor chip 300 may comprise a covering material arranged to block all RGB information and to allow IR information to pass through the second camera 300.

At least one of the two cameras 100, 102; 100, 300 may comprise an autofocus actuator to allow autofocussing of an image of a scene when the image is being captured. Alternatively or additionally, at least one of the two cameras 100, 102; 100, 300 may comprise a printed wiring board PWB/printed circuit board PCB image sensor.

It will be understood that the processor or processing system or circuitry referred to herein may in practice be provided by a single chip or integrated circuit or plural chips or integrated circuits, optionally provided as a chipset, an application-specific integrated circuit (ASIC), field-programmable gate array (FPGA), digital signal processor (DSP), graphics processing units (GPUs), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

Reference is made herein to data storage for storing data. This may be provided by a single device or by plural devices. Suitable devices include for example a hard disk and non-volatile semiconductor memory.

Although at least some aspects of the embodiments described herein with reference to the drawings comprise computer processes performed in processing systems or processors, the invention also extends to computer programs, particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the invention, which is defined in the claims.

1. A device exactly two cameras;
the first camera being a red-green-blue RGB camera for capturing RGB images;
the second camera being either:
(i) an RGB and infrared IR camera for capturing RGB images and IR images, the second camera having a selectively operable IR pass filter which can be selectively operated to pass only IR so that the second camera can be used to selectively capture an RGB image or an IR image, or
(ii) an IR camera for capturing IR images, and the device comprising a processor arranged to process IR images captured by the second camera to produce RGB images from IR images captured by the second camera by using RGB information from images captured by the first camera;
whereby the device can selectively provide two RGB images of a scene or one RGB image and an IR image of a scene from the two cameras.

2. The device according to claim 1, wherein in the case that the second camera is an IR camera, the IR camera comprises an IR sensor chip for capturing IR information of a scene.

3. The device according to claim 1, comprising a processor for combining the two RGB image of a scene or the one RGB image and the IR image of a scene to generate a single image of said scene.

4. The device according to claim 1, comprising an IR flash for illuminating a scene with IR such that reflected IR radiation may be captured by the second camera.

5. The device according to claim 1, wherein at least one of the first camera and the second camera comprise a fixed lens assembly for capturing an image of a scene.

6. The device according to claim 1, wherein in the case that the second camera is an RGB and IR camera, the selectively operable IR filter comprises a microelectromechanical systems MEMS shutter.

7. The device according to claim 1, wherein the device is a mobile user device.

8. A method of generating two images of a scene using a device having exactly two cameras, the method comprising:
capturing an RGB image of the scene by a first camera of the device;
capturing a second image of the scene by a second camera of the device, the second image being either an RGB image or an IR image of the scene;
wherein a said IR second image is obtained by either:
(i) selectively activating an IR-pass filter of the second camera in the case that the second camera is an RGB and infrared IR camera such that the second camera only captures an IR image; or
(ii) capturing an IR image of the scene in the case that the second cameras is an IR camera for capturing IR images; and
wherein a said RGB second image is obtained by either:
(i) selectively de-activating an IR-pass filter of the second camera in the case that the second camera is an RGB and infrared IR camera such that the second camera captures an RGB image; or
(ii) capturing an IR image of the scene in the case that the second camera is an IR camera for capturing IR images, and processing the IR image by a processor of the device to produce RGB images from IR images captured by the second camera by using RGB information from the image captured by the first camera.

9. The method according to claim 8, comprising combining the RGB image of the scene captured by the first camera with the second image of the scene captured by the second camera, to generate a single image of the scene.

10. The method according to claim 8, comprising illuminating the scene with IR from an IR flash of the device, such that reflected IR radiation may be captured by the second camera of the device.

11. The method according to claim 8, wherein the device is a mobile user device.
